(19) United States
(12) Patent Application Publication
(10) Pub. No.: US 2020/0337947 A1
(43) Pub. Date: Oct. 29, 2020

(54) Customizable Multichamber Device

(71) Applicant: Ahmed AboBakr Ahmed Mahmoud, Cairo (EG)

(72) Inventor: Ahmed AboBakr Ahmed Mahmoud, Cairo (EG)

(21) Appl. No.: 16/396,666

(22) Filed: Apr. 27, 2019

(51) Int. Cl. A61J 1/20; A61J 1/10; B65D 81/32

(52) U.S. Cl. CPC A61J 1/2093; A61J 1/202; B65D 81/3261; A61J 1/10

(57) ABSTRACT

This disclosure relates to a multichamber device for administration of substances to a patient. The multichamber device comprises a first end comprising one or more ports and a second end opposite of the first end. The multichamber device further comprises a first plurality of septa and a second plurality of septa dividing the interior into a plurality of chambers, the first plurality of septa being parallel with the first end and configured to open, the second plurality of septa configured to remain sealed, the chambers further divided into a main chamber abutting the first end and being wider than the rest of the plurality of chambers and the rest of the plurality of chambers being organized into columns such that the columns extend from the second end to the main chamber and are oriented so that the first plurality of septa are configured to open toward the first end. The disclosure further relates to methods of using the multichamber device.

### FIELD

This disclosure relates generally to medicine, and specifically to medical treatment.

### BACKGROUND

Medical bags are useful devices for the administration of particular drugs or other medically necessary compounds. One class of medical bags, the all-in-one medical bag holds multiple compounds for administration to patients. All-in-one medical bags allow medical professionals to provide necessary electrolytes, drugs, and other nutrients to patients. These bags provide electrolytes, a protein, and lipids to patients through intravenous administration (see, e.g., kabivenusa.com/). The bags maintain sterility and ensure a certain concentration (and therefore dose) of the materials.

Nevertheless, there are drawbacks to all-in one medical bags. A profound issue is the pre-determined dosing of these bags. The bags are shipped with a certain concentration and amounts of compounds and these cannot be changed, even if the condition of the patient requires a modification to a particular regimen. To that end, the medical professional must purchase and store many types of these bags, and then decide which bag is most suitable for his/her patient. This is a dynamic state of compromise.

Such a mechanism increases time cost and leads to potential errors. The presently known medical bags lack flexibility to allow medical professionals to tailor their treatment to a patient's needs while also protecting against the potential for infection due to sterility issues.

### SUMMARY

The present disclosure relates to a multichamber device that allows for customized administration of electrolytes, proteins (such as amino acids), and other substances such as drugs and lipids. The disclosed multichamber device further allows for accurate measurement of a substance to be administered to a patient. The multichamber device also allows for practitioners to provide measured doses of a substance in such a way that the doses remain sterile. The use of such multichamber device increases the efficiency of treatment of patients, while decreasing the likelihood of improper dosing and infection due to lack of sterility.

Aspects of the disclosed multichamber device comprises an exterior surface defining an interior. The multichamber device has a first end comprising one or more ports and a second end opposite of the first end and further comprises a first plurality of septa and a second plurality of septa dividing the interior into a plurality of chambers. The multichamber devices disclosed herein can comprise two, three, four, five, six, seven, eight, nine, or more chambers per column. In addition, the multichamber devices can comprise a plurality of columns depending on the number of substances desired to be included in the device. The first plurality of septa is parallel with the first end and configured to open and the second plurality of septa is configured to remain sealed. In some embodiments, the chambers are further divided into a main chamber abutting the first end and being wider than the rest of the plurality of chambers and the rest of the plurality of chambers being organized into columns such that the columns extend from the second end to the main chamber and are oriented so that the first plurality of septa are configured to open toward the first end.

In some embodiments, the multichamber device is a bag. In other embodiments, the multichamber device comprises a flexible material. In still other embodiments, the material is selected from the group consisting of polycarbonate, ethylene vinyl acetate, polyvinyl chloride, polypropylene, and copolyester ether.

In more embodiments, each chamber in the plurality of chambers comprises a substance located within the chamber. In still more embodiments, each chamber comprises a substance selected from the group consisting of a diluent, an electrolyte, a lipid, a protein, a drug, and a carbohydrate.

In certain embodiments, the multichamber device comprises two ports. In particular embodiments, the multichamber device comprises a port configured to allow effusion of a substance from the main chamber into a tube. In further embodiments, the first plurality of septa is configured to be an openable valve, tap, zipper, or other openable mechanism. In still further embodiments, the electrolyte is selected from the group consisting of sodium, potassium, magnesium, phosphate, bicarbonate, acetate, calcium, and other pharmaceutically acceptable electrolytes. In some embodiments, the main chamber comprises a diluent. Examples of diluents include water or other pharmaceutically acceptable diluents. Diluents can also be any substance that dissolves another substance or can be mixed with a substance. In yet further embodiments, the diluent is water. In other embodiments, the lipid is a lipid emulsion. In still other embodiments, the protein comprises intravenous amino acids. In yet other embodiments, the protein comprises amino acid solution. In more embodiments, the carbohydrate is selected from the group consisting of glucose or any other injectable carbohydrate.

In some embodiments, each chamber has a pre-determined amount of the substance. In some more embodiments, the multichamber device comprises six columns of chambers.

In other embodiments, the main chamber extends the length of the multichamber device. In yet other embodiments, the multichamber device comprises a first port and a second port. In still more embodiments, the first port connects to the interior of the main chamber.

In certain embodiments, the second port connects to one of the columns of chambers. In particular embodiments, the one of the columns of chambers contains a lipid. In more particular embodiments, the six columns each comprise a plurality of chambers. In yet more particular embodiments, each of the plurality of chambers comprises a pre-determined amount of a substance and wherein each column contains a substance different from each of the other columns. In still more particular embodiments, the substance is selected from the group consisting of a diluent, an electrolyte, a lipid, a protein, a drug, and a carbohydrate. In even more particular embodiments, the main chamber comprises a gradient measurement.

Further aspects include a method of administering a solution to a patient. The method comprises providing a multichamber device comprising a first end comprising one or more ports and a second end opposite of the first end. The multichamber device further comprises a first plurality of septa and a second plurality of septa dividing the interior into a plurality of chambers in which the first plurality of septa being parallel with the first end and configured to open, while the second plurality of septa configured to remain sealed and being perpendicular to the first end.

In some embodiments, the plurality of chambers is further divided into a main chamber abutting the first end and are wider than the rest of the plurality of chambers. In other embodiments, the rest of the plurality of chambers are organized into columns such that the columns extend from the second end to the main chamber and are oriented so that the first plurality of septa are configured to open toward the main chamber. In particular embodiments, each of the plurality of chambers comprises contents.

Aspects of the method also comprise opening one or more septa of the first plurality of septa such that the contents of one or more chambers of the plurality of chambers are dispensed from the one or more chambers of the plurality of chambers, dispensing the one or more contents of the one or more of the plurality of chambers into the main chamber, wherein the main chamber comprises a diluent, mixing the one or more contents of the one or more of the plurality of chambers with the diluent in the main chamber, and administering the contents of the main chamber to a patient through a port.

Examples of diluents include water or other pharmaceutically acceptable diluents. Diluents can also be any substance that dissolves another substance or can be mixed with a substance. In certain embodiments, the diluent is water. In some embodiments, the multichamber device is a bag. In other embodiments, the multichamber device comprises a flexible material.

In certain embodiments, the material is selected from the group consisting of polycarbonate, ethylene vinyl acetate, polyvinyl chloride, polypropylene, and copolyester ether. In particular embodiments, each chamber in the plurality of chambers comprises a substance located within the chamber.

In some embodiments, the contents of the plurality of chambers comprise a substance selected from the group consisting of a diluent, an electrolyte, a protein, a drug, and a carbohydrate. In particular embodiments, the multichamber device comprises two ports. In more particular embodiments, the multichamber device comprises a port configured to allow effusion of a substance from the main chamber into a tube. In even more particular embodiments, the first plurality of septa is configured to be an openable valve, tap, zipper, or other openable mechanism. In still more particular embodiments, the electrolyte is selected from the group consisting of sodium, potassium, magnesium, phosphate, bicarbonate, and calcium. In ever more particular embodiments, the protein comprises intravenous amino acids.

In certain embodiments, the protein comprises amino acid solution. In some embodiments, the carbohydrate is selected from the group consisting of glucose or any other injectable carbohydrate. In still other embodiments, each chamber has a pre-determined amount of the substance. In more embodiments, the multichamber device comprises six columns of chambers. In still more embodiments, the main chamber extends the length of the multichamber device.

In particular embodiments, the multichamber device comprises a first port and a second port. In some embodiments, the first port connects to the interior of the main chamber. In still some more embodiments, the second port connects to one of the columns of chambers. In even more embodiments, the one of the columns of chambers contains a lipid.

In certain embodiments, the six columns each comprise a plurality of chambers. In many embodiments, each of the plurality of chambers comprises a pre-determined amount of a substance and wherein each column contains a substance different from each of the other columns. In particular embodiments, the substance is selected from the group consisting of a diluent, an electrolyte, a protein, a drug, and a carbohydrate. In more particular embodiments, the main chamber comprises a gradient measurement.

### BRIEF DESCRIPTION OF THE DRAWINGS

The present exemplary non-limiting implementation will be described in detail herein with reference to the following drawings, in which like reference numerals refer to like elements, and wherein:

FIG. 1 is a graphical representation of an exemplary embodiment of a multichamber device;

FIG. 2 is a graphical representation of an exemplary embodiment of a multichamber device after certain chambers have been opened.

### DETAILED DESCRIPTION

The disclosed multichamber device allows for customized administration of electrolytes, proteins, and other substances such as drugs and lipids. The disclosed multichamber device further allows for accurate measurement of a substance to be administered to a patient. The multichamber device also allows for practitioners to provide measured doses of a substance in such a way that the doses remain sterile. The use of such multichamber device increases the efficiency of treatment of patients, while decreasing the likelihood of improper dosing and infection due to lack of sterility.

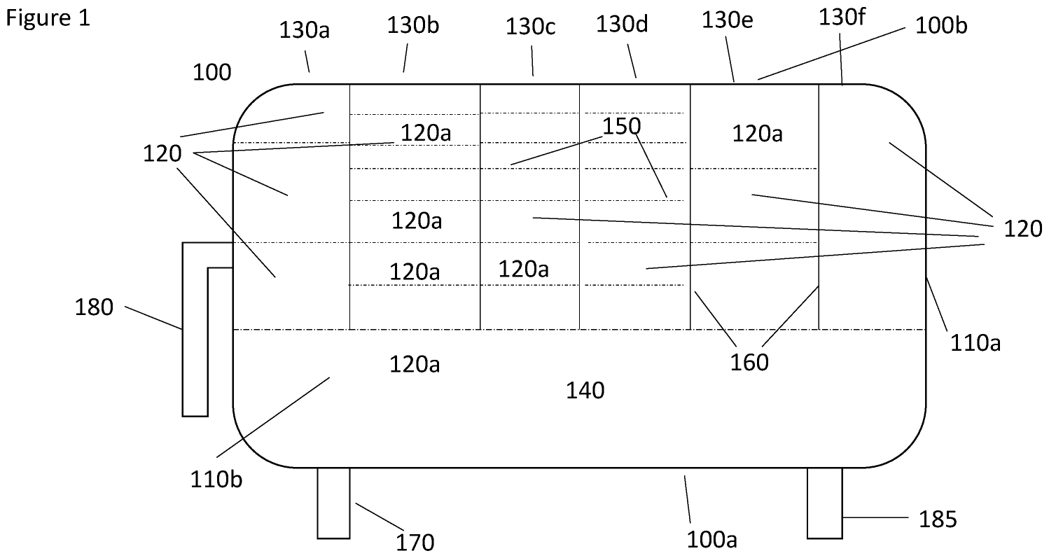

As shown in FIG. 1, the multichamber device 100 includes an exterior surface 110a and a first end 100b and a second end 100a. Although it is not shown in FIG. 1, the multichamber devices disclosed herein can comprise two, three, four, five, six, seven, eight, nine, or more chambers per column. In addition, the multichamber devices can comprise a plurality of columns depending on the number of substances desired to be included in the device. The interior of the device 110b includes a plurality of chambers 120 organized into columns 130. Each of the plurality of chambers 120 contains contents 120a. The multichamber device 100 further includes a main chamber 140 that is located at the base of the columns 130a-130f. The main chamber 140 is large enough to be at the base of each of the columns 130a-130f in this example. However, it should be noted that the main chamber 140 can be smaller such that it is located at the base of some of the columns 130. For example, column 130a contains lipid as a content 120a. If the main chamber 140 comprises a diluent such as water as a content 120a, the lipid column 120a could be designed to extend to the second end 100a of the multichamber device 100.

The chambers 120 of columns 130b and 130c comprise contents 120a that are electrolytes potassium and sodium, respectively. Column 130d contains contents 120a that are proteins, while column 130e contains contents 120a that are carbohydrates such as dextrose. Column 130f contains contents 120a that are other electrolytes such as magnesium, phosphate, bicarbonate, calcium, acetate, chloride, and other pharmaceutically acceptable electrolytes. The arrangement shown in this exemplary embodiment is not limiting and other arrangements of chambers, contents, and columns would be understood by one of ordinary skill in the art.

Each of the plurality of chambers 120 contains a pre-determined amount of contents. As will be seen from this disclosure, this allows for a medical practitioner to provide a customized amount of a substance to a patient. Examples of substances include drugs, electrolytes, proteins, lipids, carbohydrates, and other substances that can be administered through an IV to a patient.

The multichamber device 100 of FIG. 1 comprises a first plurality of septa 150 and a second plurality of septa 160. The first plurality of septa 150 is parallel to the second end 100a of the device 100. The second plurality of septa 160 is perpendicular to the second end 100a. As used herein, the term “parallel” means side by side but not necessarily maintaining the same distance between the two lines. For example, the septa 150 and the second end 100a would be considered parallel even if they would eventually intersect if drawn out toward infinity. As used herein, the term “perpendicular” means that a line will eventually intersect with another line irrespective of whether the lines are at an angle of 90 degrees.

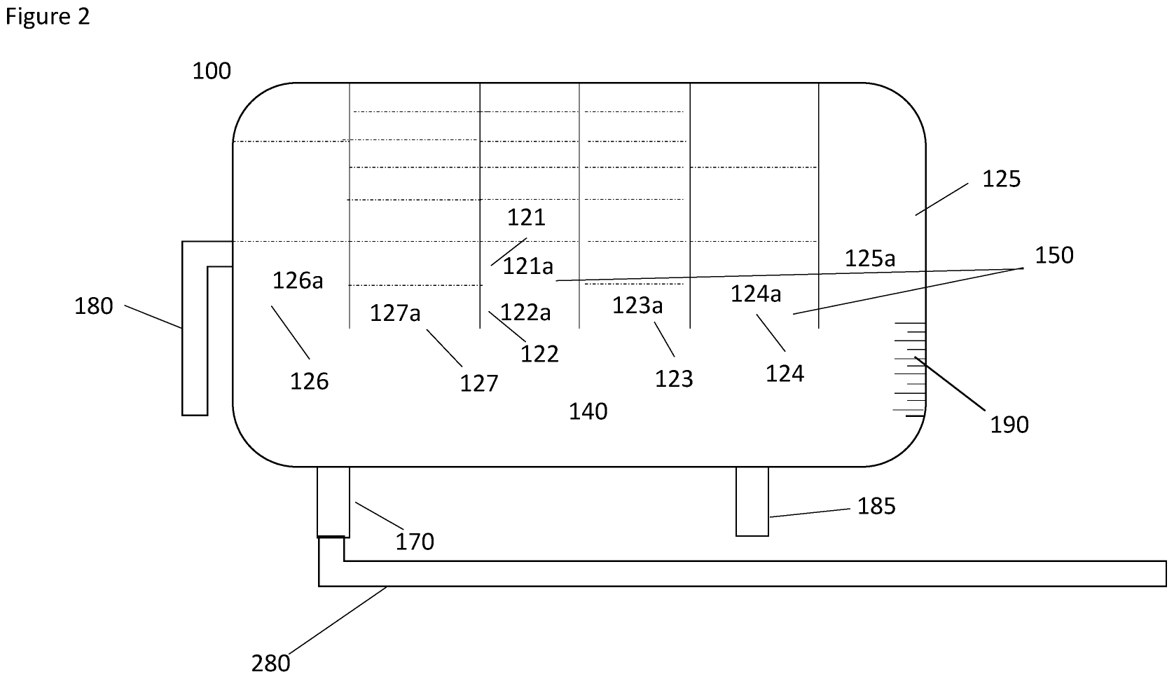

In this example, the second plurality of septa 160 are designated with solid lines because they are designed to remain structurally intact at all times. The second plurality of septa 160 continuously separate the contents 120a of chambers from entering each other. On the other hand, the first plurality of septa 150 are designed to open and allow contents to leave a chamber and enter another chamber. The first plurality of septa 150 act as an openable divider. When operated in practice, the first plurality of septa 150 allow a medical practitioner to adjust the amount of a substance to be administered to a patient. The more chambers 120 that are opened and allowed to be administered to the patient, the higher the dose administered. In the case of electrolytes that must be dissolved in water, chambers 120 are opened and allowed to disperse into the main chamber 140. The electrolytes are dissolved, mixed, or diluted in the water and then the medical practitioner opens port 170 to allow the solution to move through the port 170 into an IV line 280 shown in FIG. 2. Also shown in FIG. 1, port 185 connects to the first end and can be used to drain material from the main chamber 140. Port 185 can also connect to an IV line (not shown). In addition, port 185 can be used to add additives to the device if needed.

It should be noted that column 130a comprises lipids in this example. In this example, column 130a is operably connected to a port 180 dedicated to column 130a. Column 130a is divided into chambers 120 that allow for particular dosing of lipids. In some embodiments, the main chamber 140 comprises a diluent that comprises a buffered solution. In other embodiments, the main chamber 140 comprises a diluent that allows for dissolution of hydrophobic molecules such as certain hydrophobic proteins, lipids, or fatty acids. In particular embodiments, the main chamber 140 includes an emulsion.

The multichamber device 100 also includes a gradient measure 190 on a side of the main chamber 140. The gradient measure 190 provides an indication of the volume of solution remaining in the main chamber 140. In some embodiments, the main chamber 140 includes from about 20 ml to about 3.0 L. In some embodiments, the main chamber 140 comprises from about 3.0 L to about 10.0 L. In other embodiments, the main chamber 140 comprises from about 10.0 L to about 20.0 L.

The disclosed multichamber device can be made of a multitude of materials. Exemplary materials include polycarbonate, ethylene vinyl acetate, polyvinyl chloride, polypropylene, copolyester ether, and materials that are flexible. The multichamber device can comprise a combination of materials to allow for the holders to be flexible and resistant to extreme physical distortion while maintaining flexibility. For instance, the multichamber device can comprise a composite material that is flexible. In some embodiments, the multichamber device further comprises thermosetting polymers or other materials that cure the material. It should be noted that, in some embodiments, the multichamber device is comprised of materials are flexible.

The manufacturing process for the multichamber device 100 can include standard technologies such as sealing two films or more together and welding the septa 150 and 160 for creation of the chambers 120 and introducing ports 170/180/185. The manufacturing process can include first filling the main chamber 140 with a solvent, emulsifier, or dispersant. The plurality of chambers 120 can then be filled with a pre-determined amount of contents 120a into each chamber of the plurality of chambers 120. Each chamber can be sealed as it is filled. The process can be performed using sterile techniques to maintain sterility and prevent contamination. The filling means may encompass a simple filling nozzle, a filling tube, a syringe, or a cannula.

One method of forming multichamber device 100 includes the technique of thermoforming. Thermoforming is a well-known manufacturing process where a plastic sheet is heated to a pliable forming temperature, formed to a specific shape in a mold, and trimmed to create a usable product. The sheet, film or foil when referring to thinner gauges and certain material types, is heated to a sufficient temperature permit ting it to be stretched into or onto a mold to a desired finished shape. Its simplified version is vacuum forming. In its simplest form, a small tabletop or lab size machine can be used to heat small cut sections of plastic sheet and stretch it over a mold using vacuum or overpressure. This method is often used for sample and prototype parts.

Thermoforming can be performed on a single film or foil resulting in exposure of both film sides to the open atmosphere. In some embodiments, an upper and lower film can be directly and simultaneously thermoformed at the same time (on the same or opposite site) by vacuum and/or overpressure applied to the outer area while simultaneously welding the circumference to form the exterior and interior of the device. By this method, the inner face of the device is thereby never in contact with the open atmosphere. The interior chambers can be made by introducing septa by welding as well.

FIG. 2 shows an exemplary embodiment of the multichamber device 100 in which the device is in use. In this embodiment, chambers 121-127 have been opened and the contents 121a-127a have been disposed into the main chamber 140. As can be seen, the main chamber 140 is operably connected to port 170 and the contents of main chamber 140 are moving through port 170 into an IV tube 280 and onto the patient (not shown). As is readily seen, the patient is receiving a higher dose of sodium than potassium due to two chambers 121 and 122 being opened for sodium content 121a and 122a, while potassium content 127a from chamber 127 are opened. The potassium and sodium from chambers 121/122 and 127, respectively, are allowed into the main chamber 140. As can be seen, chamber 121 empties into chamber 122 and when the septa 150 are opened (e.g., broken), the contents 121a and 122a of chambers 121 and 122 are emptied into the main chamber 140 for mixing in the diluent. When septa are opened for chamber 127 is opened, the contents 127a are released into main chamber 140. This process can be repeated across columns.

Chambers 124, 125, and 126 further been opened. Chamber 126 contains a pre-determined amount of lipid 126a such as fatty acids, triacylglycerides, or combinations thereof. Chamber 124 contains amino acids 124a. Chamber 126 is operably connected to its own port 180 and the lipids are allowed to flow out of port 180 when port 180 is opened. Chamber 123 comprises carbohydrates 123a. Examples of carbohydrates include glucose or any other injectable carbohydrate. In FIG. 2, the contents 125a are dissolved in the main chamber 140 along with the contents 121a and 122a. Chamber 125 comprises a mixture of other electrolytes.

The contents 120a of the multichamber device 100 can be provided in powder form, emulsion form, dispersion form, and liquid form. The contents 120a should be sterile and sterilization processes for the making of substances are known in the art. In addition, the contents 120a can be a drug or other active agent.

It should be noted that the use of the term “a” or “an” means “one or more” throughout this application unless explicitly described otherwise. As used herein, the term “about” means+/−10% of the value provided unless otherwise indicated.

### EQUIVALENTS

Those skilled in the art will recognize, or be able to ascertain, using no more than routine experimentation, numerous equivalents to the specific embodiments described specifically in this disclosure. Such equivalents are intended to be encompassed in the scope of the following claims.

1. A multichamber device comprising an exterior surface defining an interior, the multichamber device having a first end comprising one or more ports and a second end opposite of the first end, the multichamber device further comprising a first plurality of septa and a second plurality of septa dividing the interior into a plurality of chambers, the first plurality of septa being parallel with the first end and configured to open, the second plurality of septa configured to remain sealed, the chambers further divided into a main chamber abutting the first end and being wider than the rest of the plurality of chambers and the rest of the plurality of chambers being organized into columns such that the columns extend from the second end to the main chamber and are oriented so that the first plurality of septa are configured to open toward the first end.

2. (canceled)

3. The multichamber device of claim 1, wherein the multichamber device comprises a flexible material.

4. The multichamber device of claim 3, wherein the material is selected from the group consisting of polycarbonate, ethylene vinyl acetate, polyvinyl chloride, polypropylene, and copolyester ether.

5. The multichamber device of claim 1, wherein each chamber in the plurality of chambers comprises a substance located within the chamber.

6. The multichamber device of claim 5, wherein each chamber comprises a substance selected from the group consisting of a diluent, an electrolyte, a lipid, a protein, a drug, and a carbohydrate.

7. The multichamber device of claim 1, wherein the multichamber device comprises two ports.

8. The multichamber device of claim 1, wherein the multichamber device comprises a port configured to allow effusion of a substance from the main chamber into a tube.

9. The multichamber device of claim 1, wherein the first plurality of septa is configured to be an openable valve, tap, zipper, or other openable mechanism.

10. The multichamber device of claim 6, wherein the electrolyte is selected from the group consisting of sodium, potassium, magnesium, phosphate, bicarbonate, acetate, and calcium.

11.-13. (canceled)

14. The multichamber device of claim 6, wherein the protein comprises amino acid solution.

15. The multichamber device of claim 6, wherein the carbohydrate is selected from the group consisting of glucose and injectable carbohydrates.

16. (canceled)

17. The multichamber device of claim 1, wherein the multichamber device comprises six columns of chambers.

18. (canceled)

19. The multichamber device of claim 1, wherein the multichamber device comprises a first port and a second port.

20. The multichamber device of claim 19, the first port connects to the interior of the main chamber.

21. The multichamber device of claim 20, wherein the second port connects to one of the columns of chambers.

22. The multichamber device of claim 21, wherein the one of the columns of chambers contains a lipid.

23. The multichamber device of claim 17, wherein the six columns each comprise a plurality of chambers.

24. The multichamber device of claim 23, wherein each of the plurality of chambers comprises a pre-determined amount of a substance and wherein each column contains a substance different from each of the other columns.

25. The multichamber device of claim 24, wherein the substance is selected from the group consisting of a diluent, an electrolyte, a lipid, a protein, a drug, and a carbohydrate.

26. The multichamber device of claim 1, wherein the main chamber comprises a gradient measurement.

27-51. (canceled)
